(19) United States
(12) Patent Application Publication
(10) Pub. No.: US 2007/0056992 A1
(43) Pub. Date: Mar. 15, 2007

(54) Post mounted container

(75) Inventors: Chris Brew, Phoenix, AZ (US); Raymond Zuckerman, Scottsdale, AZ (US); Virginia Barnes, Mesa, AZ (US)

Correspondence Address: WEISS & MOY PC, 4204 NORTH BROWN AVENUE, SCOTTSDALE, AZ, 85251, US

(73) Assignee: CHRIS BREW

(21) Appl. No.: 11/223,841

(22) Filed: Sep. 9, 2005

(51) Int. Cl. B67D 5/64

(52) U.S. Cl. 222/174

(57) ABSTRACT

A post mounted container configured to allow a user to easily secure and remove the container to a post, such as the types of posts used in building construction. The post mounted container could be use to dispense liquids or store objects while being supported above a ground surface mounted to a post.

### FIELD OF INVENTION

This invention relates generally to containers, and more specifically to a container having a channel dimensioned to couple to a post and a securing device that allows the container to be secured to and removed from the post.

### BACKGROUND OF THE INVENTION

Often on a building site drinking water is unavailable. In an effort to provide employees with drinking water, builders will attach water containers to construction vehicles, or place water containers on the ground. Unfortunately, these containers are not readily accessible to employees who are working on a building's framing some distance above the ground. If those employees want a drink they must climb down to the ground—a journey that is dangerous and time consuming—to use the water containers.

Construction crews try several methods to provide drinking water to those employees that work above the ground floor. They may construct a special above-ground frame in which to store a standard water cooler. This is, of course, time consuming and expensive and greatly restricts the transportability of the cooler. In fact, for a crew working some distance away from the frame this solution may create as much frustration as a water cooler stored on the ground floor. Some crews try to secure a standard cooler to construction posts, such as studs, using rope or some other removable material. However, this method results in an unstable and dangerous installation of a water cooler.

Some prior art exists that may be relevant to this invention. U.S. Pat. No. 6,267,461, issued to Dunagan et al., describes a sports ball holder that can be fixed to a vertical post. However, the fixing mechanism requires the use of tools and results in a semi-permanent installation. In addressing the needs met by the instant invention a semi-permanent installation is unacceptable. Another patent, U.S. Pat. No. 6,338,419 issued to Penney, describes a container that can be attached to a vertical pole having a circular cross-section. The Penney invention is unsatisfactory in meeting current needs as the mounting mechanism relies on the presence of a circular pole, while construction posts typically come in a square or rectangular configuration known as studs. Additionally, the mounting mechanism in the Penney invention rely on ‘shape-memory’ material to create sufficient friction with the pole to mount the container, a method that would be unsafe if used to address current needs.

A need therefore existed for a container that could be mounted to and removed from a post and used to dispense liquid that would allow workers, who work above the ground floor where running water is not available, to get a drink without having to climb down to the ground floor. In addition, a container capable of being easily mounted to and removed from a construction site stud allows workers to easily bring the container with them from location to location on a construction site.

### SUMMARY OF THE INVENTION

An object of the present invention is to provide a post mounted container with a walled channel that is dimensioned to allow a user to place the channel around a post and a support device to allow a user to secure the container to the post. The user can then dispense liquid from the container and later remove the container from the post.

It is a further object of the present invention to provide a container capable of being easily mounted to and removed from a standard construction stud.

### BRIEF DESCRIPTION OF THE PREFERRED EMBODIMENTS

In accordance with one embodiment of the present invention, a post mounted container is disclosed. The post mounted container comprises, in combination, a container having an interior wall, exterior wall, closed end and an open end. A first ridge is coupled along a length of the exterior wall of the container. A second ridge is coupled along a length of the exterior wall of the container. The two ridges together define a channel that is dimensioned to mate with a post. Additionally, a securing device dimensioned to secure the container to a post is coupled to the container.

In accordance with a second embodiment of the present invention, a post mounted container is disclosed. The post mounted container comprises, in combination, a container having an interior wall, exterior wall, closed end and an open end. The exterior wall of the container defines a channel that is dimensioned to mate with a post. Additionally, a securing device dimensioned to secure the container to a post is coupled to the container.

In accordance with a third embodiment of the present invention, a post mounted container is disclosed. The post mounted container comprises, in combination, a container having an interior wall, an exterior wall, a closed end and an open end. A mounting bracket having a front side, a back side, a top surface and a bottom surface is dimensioned to couple to the exterior wall of the container. A first ridge is coupled along a length of the front side of the mounting bracket. A second ridge is coupled along a length of the front side of the mounting bracket. The first ridge and the second ridge define a channel that is dimensioned to mate with a post. A securing device is coupled to at least one of the first ridge and the second ridge. The securing device is dimensioned to secure the mounting bracket to the post.

In accordance with a fourth embodiment of the present invention, a method for mounting a post mounted container is disclosed. The method comprises the steps of providing a container having an interior wall, exterior wall, open end and a closed end. The method further comprises the steps of providing a first ridge and a second ridge coupled along a length of the exterior wall and together defining a channel dimensioned to mate with a post, placing the container in contact with the post with an interior surface of the first ridge proximate a first exterior side of the post and with an interior surface of the second ridge proximate a second exterior side of the post so that the post is mated with the channel of the container, and securing the container to the post with a securing device.

In accordance with a fifth embodiment of the present invention, a method for mounting a post mounted container is disclosed. The method comprises the steps of providing a container having an interior wall, an exterior wall, an open end and a closed end. The method further comprises the steps of providing a mounting bracket having a front side, a back side, a top surface and a bottom surface. The mounting bracket is dimensioned to couple to the exterior wall of the container. The method further comprises the steps of providing a first ridge coupled along a length of the front side of the mounting bracket and providing a second ridge coupled along a length of the front side of the mounting bracket. The first ridge and the second ridge define a channel that is dimensioned to mate with a post. The method further comprises the steps of placing the mounting bracket in contact with the post with an interior surface of the first ridge proximate a first exterior side of the post and with an interior surface of the second ridge proximate a second exterior side of the post so that the post is mated with the channel of the container. The method further comprises the steps of securing the mounting bracket to the post with a securing device and coupling the container to the mounting bracket.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a left perspective view of a first embodiment of the post mounted container of the present invention. The container is shown as being secured to the post by a clamp and a stabilizing leg that are coupled proximate a closed end of the container. The stabilizing leg is shown to be in contact with the post.

FIG. 2 is a right perspective view of the post mounted container of FIG. 1. The container is shown as being secured to the post by a clamp coupled proximate the open end of the container and a stabilizing leg coupled proximate the closed end of the container. The stabilizing leg is shown to be in contact with a ground surface.

FIG. 3 is a left perspective view of a second embodiment of the post mounted container of the present invention. The container is shown as being secured to the post by a cord-type material coupled proximate the open end of the container and a clamp coupled proximate the closed end of the container.

FIG. 4 is a right perspective view of the post mounted container of FIG. 3. The container is shown as being secured to the post by the cord-type material coupled proximate the open end of the container.

FIG. 5 is a right perspective view of the post mounted container of FIG. 1. The container is shown as having an indicator for easy determination of the amount of water contained in the cooler.

FIG. 6 is a left perspective view of a third embodiment of the post mounted container of the present invention. The container is shown as being secured to the post by a first clamp coupled proximate the open end of the container and a second clamp coupled proximate the closed end of the container.

FIG. 7 is a partial perspective view of the closed end of the post mounted container of FIG. 6.

FIG. 8 is a rear view of the post mounted container of FIG. 3, showing a first embodiment of a securing device.

FIG. 9 is a top view of the post mounted container of FIG. 2, showing a second embodiment of the securing device.

FIG. 9A is a cross-sectional view of the post mounted container and securing device of FIG. 9.

FIG. 9B is a bottom view of the post mounted container of FIG. 4.

FIG. 9C is a bottom view of the post mounted container of FIG. 3.

FIG. 9D is a bottom view of the post mounted container of FIG. 1.

FIG. 9E is a top view of the securing device of FIG. 9.

FIG. 10 is a left perspective view of a third embodiment of the post mounted container of the present invention. The container is shown being coupled to the mounting bracket.

FIG. 11 is a left perspective view of the post mounted container of FIG. 10. The container is shown as being secured to the post by a mounting bracket.

FIG. 12 is a top view of the post mounted container of FIG. 10. The container is shown being uncoupled from the mounting bracket.

FIG. 12A is a top view of the post mounted container of FIG. 11.

FIG. 12B is a bottom view of the post mounted container of FIG. 11.

### DETAILED DESCRIPTION OF THE PREFERRED EMBODIMENTS

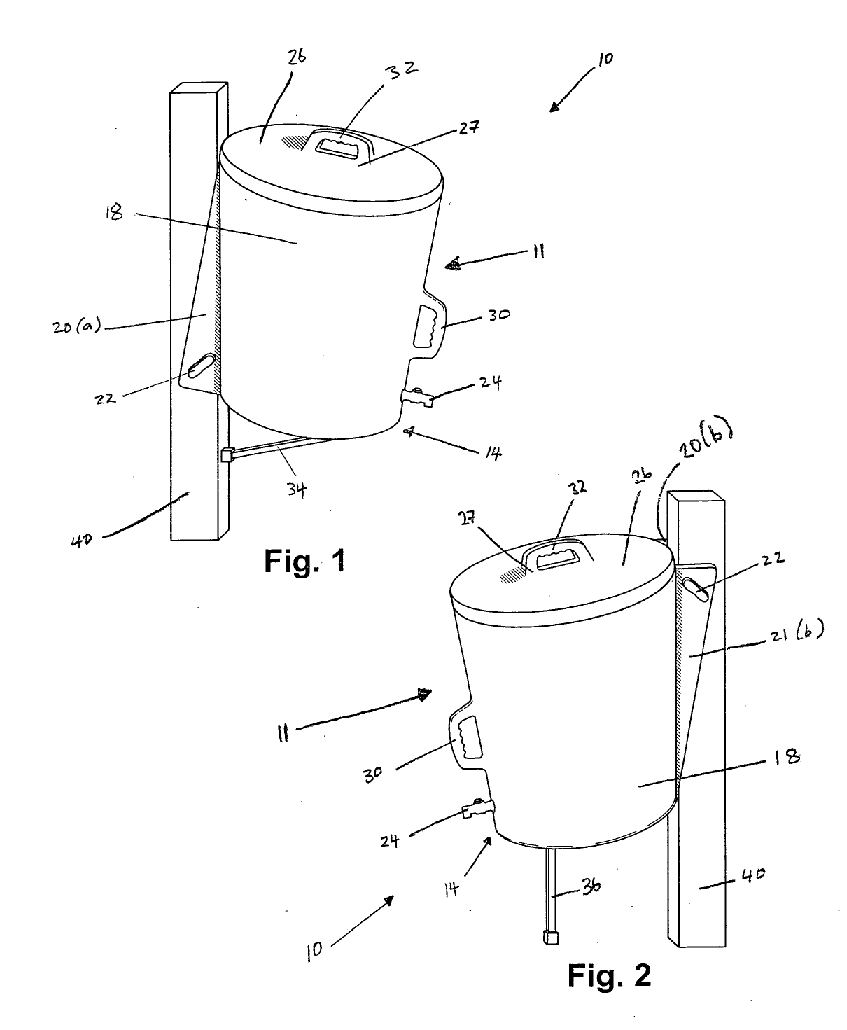

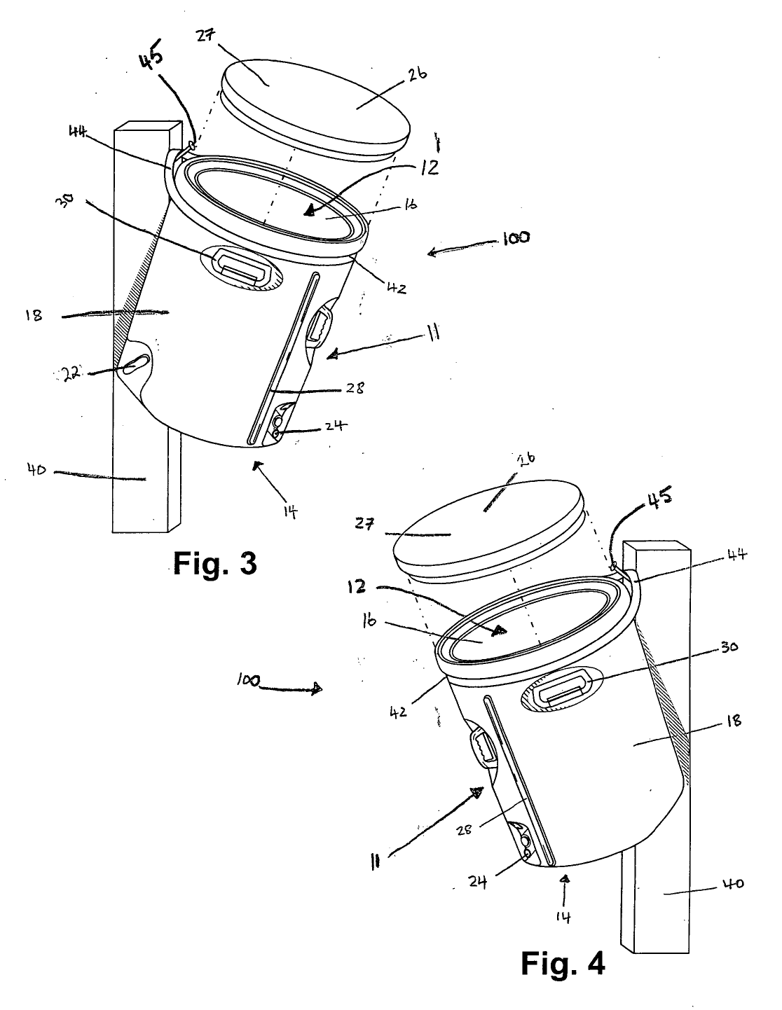

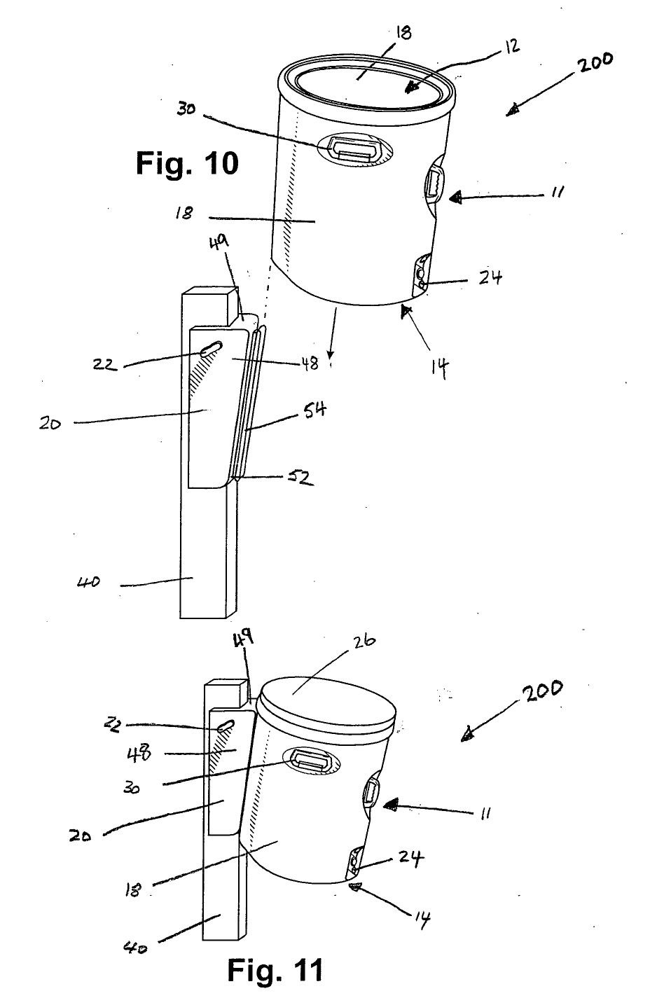

As shown in FIGS. 1-12D for purposes of illustration, the present invention is concerned with a post mounted container, designated in the accompanying drawings by the reference number 10 (see FIGS. 1, 2, 5-7, 9, 9A, and 9D), reference number 100 (see FIGS. 3, 4, 9B, and 9C) and reference number 200 (see FIGS. 10-12B).

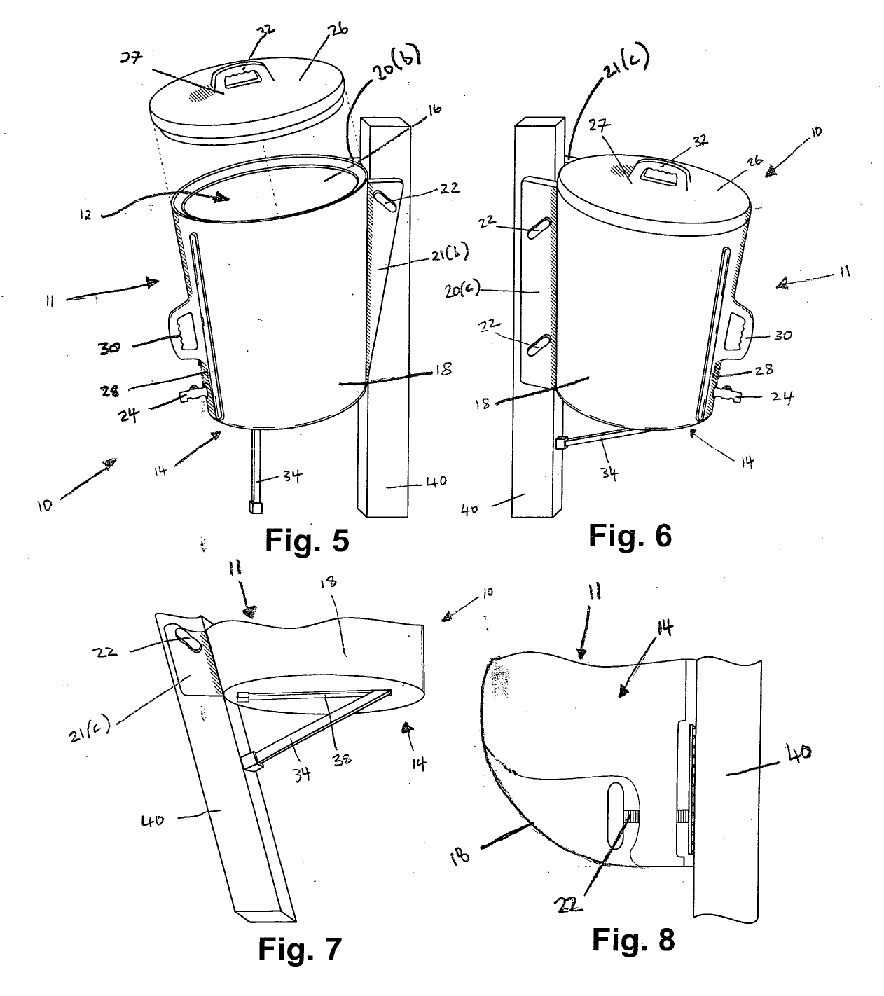

Referring now to FIGS. 1, 2, 5 and 6, a first embodiment of post mounted container 10 is shown. Post mounted container 10 comprises a container 11 having an open end 12 (see FIG. 5), closed end 14, interior wall 16 (see FIG. 5) and an exterior wall 18. It is preferred that container 11 comprises material having high heat insulative properties or any other suitable material. Additionally, it is preferred that container 11 be constructed using an injection molding technique or any other suitable construction technique. While, in the preferred embodiment, container 11 is comprised of an injection molded material having heat insulative properties, it should be clearly understood that substantial benefit could be derived from an alternative embodiment of the present invention in which neither injection molding nor heat insulative materials are used, so long as container 11 is capable of storing a liquid.

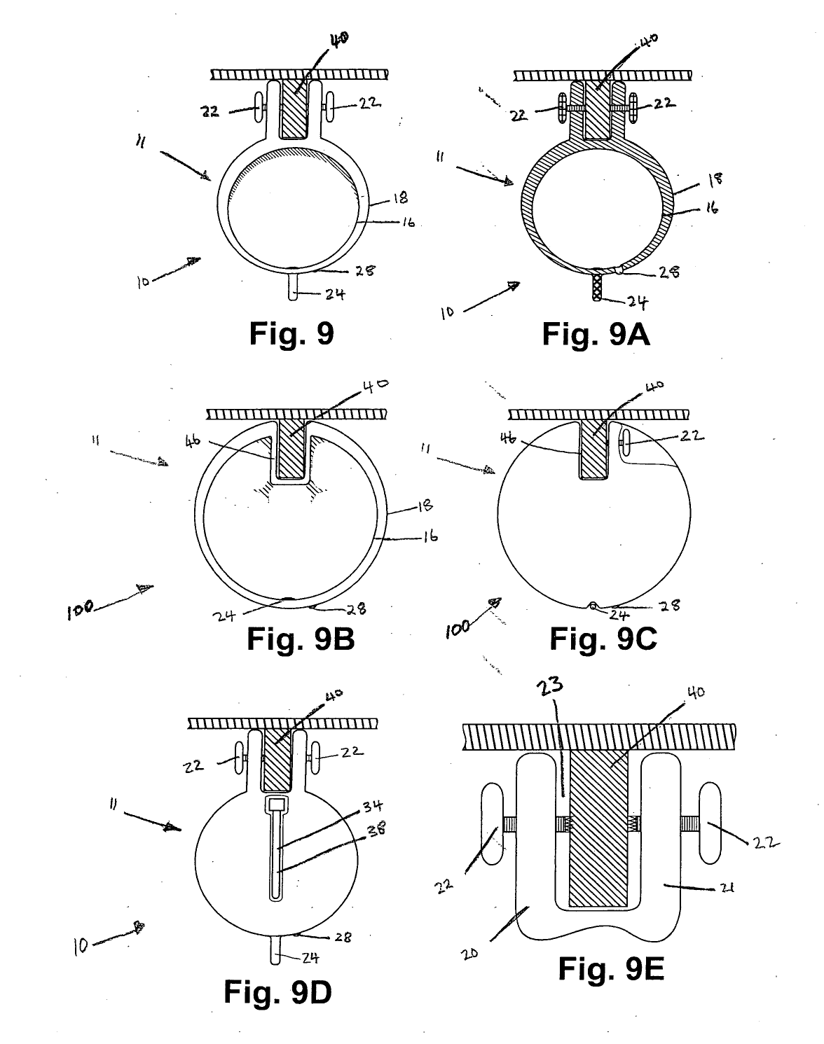

Referring now to FIGS. 1, 2, 5, 6, and 9E, coupled to exterior wall 18 (see FIGS. 1, 2, 5 and 6) are both a first ridge, generally referred to as first ridge 20 (see FIGS. 1, 6 and 9E) and a second ridge, generally referred to as second ridge 21 (see FIGS. 2, 5 and 9E). Ridges 20 and 21 form a channel 23 (see FIG. 9E) that is substantially dimensioned to mate with a post 40. It should be noted that channel 23 formed by first ridge 20 and second ridge 21 is preferably between approximately one to six inches wide and between approximately one to six inches deep. Channel 23 is preferably dimensioned to mate with one of many standard construction studs having various dimensions. Typically, such studs are either square or rectangular in shape and can be made of wood, metal or some other durable material. Such standard construction studs may include, but are not limited to:
Studs (4×4 or 6×6)
Studs (2×4, 2×6, 2×8 or 2×10)
Boards (2×4, 2×6 or 1×6)

In one embodiment of post mounted container 10, shown in FIG. 1, first ridge 20(a) and second ridge (not shown) have a greater height proximate closed end 14 and a lesser height proximate an open end covered by lid 26.

In another embodiment of post mounted container 10, shown in FIGS. 2 and 5, first ridge 20(b) and second ridge 21(b) have a greater height proximate open end 12 and a lesser height proximate closed end 14 of container 11.

Referring now to FIG. 6, yet another embodiment of post mounted container 10 is shown wherein first ridge 20(c) and second ridge 21(c) are not tapered.

Referring now to FIGS. 1-2 and 5-12B, at least one securing device 22 may be coupled to container 11 in many different ways. FIG. 1 shows a securing device 22 coupled to first ridge 20(a) proximate closed end 14 of container 11. FIGS. 2 and 5 show a securing device 22 coupled to second ridge 21(b) proximate open end 12 of container 11. While, FIGS. 1, 2 and 5 show only one securing device 22 coupled to one ridge, it should be clearly understood that substantial benefit could be derived from an alternative embodiment of the present invention, in which post mounted container 10 comprises two securing devices 22 one for both first ridge 20 and second ridge 21. FIG. 6 shows securing devices 22 coupled to first ridge 20(c) proximate both open end 12 and closed end 14 of container 11. It should be clearly understood, however, that substantial benefit could be derived from an alternative embodiment of the present invention, in which post mounted container 10 shown in FIG. 6 comprises four securing devices 22, two for first ridge 20(c) and two for second ridge 21(d), with one securing device 22 on each ridge proximate closed end 14 and one securing device 22 on each ridge proximate open end 12 covered by lid 26.

It should be noted that securing devices 22 are preferably dimensioned to secure container 11 to post 40. It is within the spirit sand scope of this invention that any type of clamps, screws, teeth or some combination thereof may be incorporated into securing device(s) 22, so long as securing device 22 is in any way capable of assisting the coupling of container 11 to be mounted on post 40. While the preferred embodiments show securing devices 22 being coupled to first ridge 20 and second ridge 21 proximate open end 12 and/or closed end 14 of container 11, it should be clearly understood that securing devices 22 may be coupled to first ridge 20 and second ridge 21 at any point therealong.

Referring now to FIGS. 1-6 and 11, post mounted container 10 preferably further comprises a lid 26 dimensioned to couple with open end 12. FIGS. 3-5 show lid 26 removed from open end 12. A handle 32 (see FIGS. 1, 2, 5, and 6) is preferably coupled to outer surface 27 of lid 26. Additionally, handles 30 (see FIGS. 1-6) may be coupled to exterior wall 18 of post mounted container 10 to assist in lifting, carrying or positioning container 11. It should be noted that handles 32 and 30 may be molded into the outer surfaces of the lid 26 and exterior wall 18 (as shown in FIGS. 1, 2, 5, and 6). Additionally, any handles that are coupled to exterior wall 18 may be recessed to prevent them from sustaining damage (see FIGS. 3 and 4). While, in the preferred embodiment, handles 32 and 30 are coupled to container 11, it should be clearly understood that substantial benefit could be derived from an alternative configuration of the present invention in which there are no handles or in which some other grasping or lifting mechanism is used.

Referring now to FIGS. 3, 4, 5, 6 and 9A, preferably, a volume indicator 28 is coupled to exterior wall 18 of post mounted container 10. Volume indicator 28 is preferably a window approximately ½ inch wide that runs along exterior wall 18 from proximate closed end 14 to open end 12, although it should be clearly understood that substantial benefit could be derived from an alternative embodiment of the present invention in which an alternatively configured volume indicator is used, such as one that is proximate only closed end 14, or in which there is no volume indicator 28.

Referring now to FIGS. 1-6, a spout 24 is preferably coupled to exterior wall 18 of post mounted container 10 proximate closed end 14. It should be noted that spout 24 may protrude, as seen in FIGS. 1, 2, 5, and 6, or spout 24 may be recessed into exterior wall 18, as seen in FIGS. 3 and 4, minimizing the probability that spout 24 will be damaged or broken. While, in the preferred embodiment, post mounted container 10 comprises a spout 24 dimensioned to dispense liquid from container 11, it should be clearly understood that substantial benefit could be derived from an alternative embodiment of the present invention in which there is no spout 24, such as a container 11 for storing something other than liquid (for example building supplies), or for a liquid storing container 11 in which the liquid is dispensed by dipping a cup into open end 12 of container 11.

Referring now to FIGS. 1, 2, 5, 6 and 7, post mounted container 10 preferably further comprises a stabilizing leg 34 coupled to an exterior portion of closed end 14 of post mounted container 10. Stabilizing leg 34 is dimensioned to contact any object in order to support closed end 14 of container 11 above a ground surface. FIG. 1 shows stabilizing leg 34 bracing against a post 40. It should be noted that stabilizing leg 34 could be used in different configurations. For example, FIG. 2 shows stabilizing leg 34 in a substantially vertical position bracing against a ground surface. FIG. 5 shows a recessed area 38 in exterior portion of closed end 14 of post mounted container 10 that is substantially dimensioned to receive stabilizing leg 34 in a stored position, although it should be clearly understood that substantial benefit could be derived from an alternative configuration of post mounted container 10 in which there is no recessed area 38. While, in the preferred embodiment, post mounted container 10 comprises a stabilizing leg 34, it should be clearly understood that substantial benefit could be derived from an alternative configuration of the present invention in which there is no stabilizing leg 34 and only a securing device 22, or in which some other device is used to provide additional support to container 11.

Referring now to FIGS. 3, 4, 9B and 9C an alternative embodiment of post mounted container 10, hereinafter post mounted container 100 is shown. Post mounted container 100 is essentially the same as post mounted container 10, except that instead of external ridges that protrude from external surface 18 to define a channel dimensioned to mate with post 40, external surface 18 of container 11 defines a channel 46 (see FIGS. 9B and 9C) dimensioned to mate with post 40. For this reason, the same reference numbers used in describing the features of post mounted container 10 will be used when describing the identical features of post mounted container 100. Preferably, proximate open end 12 exterior wall 18 forms an annular flange 42 (see FIGS. 3-4) dimensioned to receive a cord-type material 44 (see FIGS. 3-4). Cord-type material 44 is dimensioned to couple container 11 to post 40. For example, the length of flexible material 44 could loop over a nail 45 (see FIGS. 3-4) that has been driven into post 40, or the cord-type material 44 could be used to wrap around a post 40. Cord-type material 44 may be used either to supplement securing device 22 (see FIGS. 3, 9B, 9C) or to act as the securing device (see FIG. 4).

Referring to FIGS. 3, 9B and 9C, coupled to exterior wall 18 proximate channel 46 is a securing device 22 that is dimensioned to couple post mounted container 10 to post 40. It should be noted that securing device 22 could be placed at any point along channel 46.

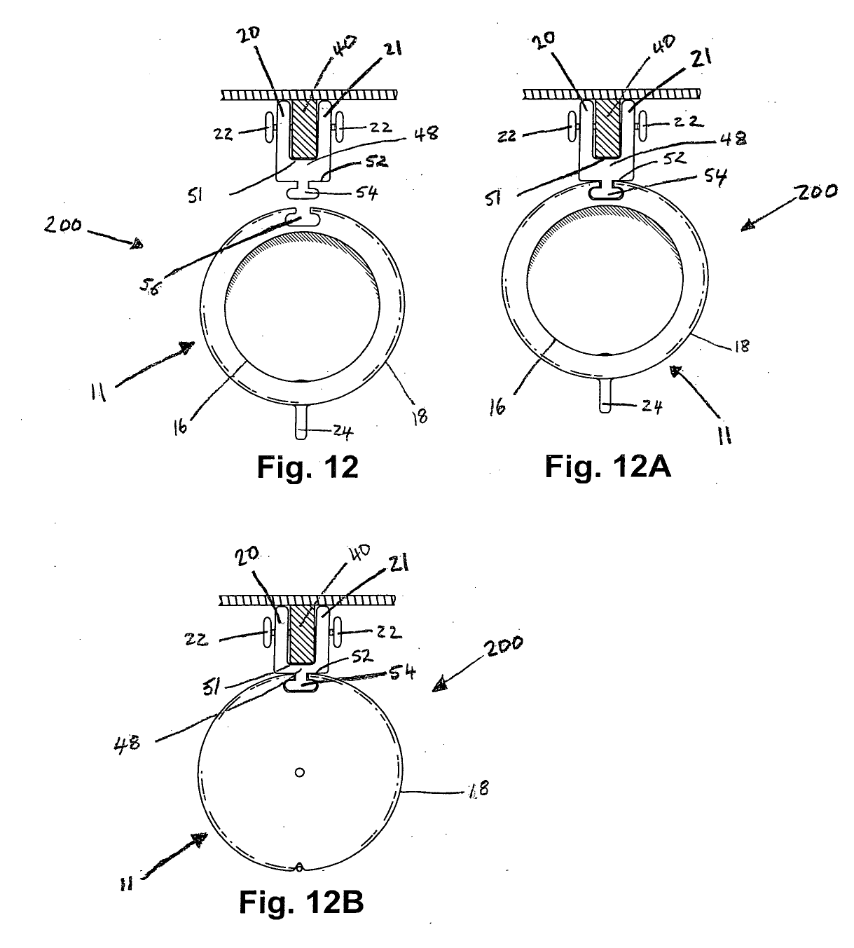

Referring now to FIGS. 10-12B, an alternative embodiment of post mounted container 10, hereinafter post mounted container 200 is shown. Post mounted container 200 is essentially the same as post mounted container 10, except that ridge 20 and ridge 21 are coupled to a front surface 51 of a mounting bracket 48. For this reason, the same reference numbers used in describing the features of post mounted container 10 will be used when describing the identical features of post mounted container 200. Ridge 20 and ridge 21 (see FIGS. 12, 12A, and 12B) form a channel substantially dimensioned to couple to a post 40 and with a preferable length of approximately the height of container 11. It should be noted that the length of mounting bracket 48 (and accordingly, tongue 54 (see FIGS. 10, 12, 12A and 12B) and groove 56 (see FIGS. 12) could be substantially decreased without denying a user the benefits of the device. Securing device 22 is preferably coupled to ridge 20 proximate top surface 49 (FIGS. 10 and 11) of mounting bracket 48. An additional securing device 22 is preferably coupled to ridge 21 proximate top portion 49 of mounting bracket 48. It should be noted that substantial benefit could be derived from a post mounted container 10 having a different number of securing devices 22 being coupled to one of ridge 20 and ridge 21. For example, securing devices 22 could be could to ridge 20 or ridge 21 proximate a bottom surface 47. Alternatively, a stabilizing leg could be used in place of securing devices 22.

Mounting bracket 48 is detachably coupled to exterior wall 18 of container 11 preferably by means of a tongue-in-groove system. A groove 56 is formed in exterior wall 18 of container 11. Groove 56 is substantially dimensioned to mate with tongue 54 that is coupled to a back surface 52 (see FIGS. 10, 12, 12A and 12B) of mounting bracket 48. Width of tongue 54 and width of groove 56 are preferably tapered from proximate open end 12 to closed end 14 of post mounted container 200 wherein width of tongue 54 and width of groove 56 are preferably greater proximate open end 12 and lesser proximate closed end 14 of container 11. This design allows container 11 to be securely coupled to mounting bracket 48. It should be noted that substantial benefit could be derived from a tongue 54 and groove 56 having a different design. For example, location of tongue 54 and groove 56 could be reversed so that tongue 54 is coupled to exterior wall 18 of container 11 and groove 56 is formed in back surface 52 of mounting bracket 48. Also, a tongue-in-groove system could be implemented with multiple tongue 54 and groove 56 elements. Additionally, width of tongue 54 and width of groove 56 does not have to taper from open end 12 to closed end 14 of container 11. Instead, any dimension (such as depth) of tongue 54 and groove 56 could be tapered and still provide a method of fixing container 11 to mounting bracket 48. While, in the preferred embodiment, post mounted container 200 comprises a tongue-in-groove system, it should be clearly understood that substantial benefit could be derived from an alternative means of coupling mounting bracket 48 to container 11 so long as this can be done securely.

While the invention has been particularly shown and described with reference to preferred embodiments thereof, it will be understood by those skilled in the art that the foregoing and other changes in form and details may be made therein without departing from the spirit and scope of the invention. For example, other forms of securing devices 22 may be used, so long as securing device 22 is able to secure the container 11 to a post 40.

We claim:

1. A post mounted container comprising:
a container having an interior wall and an exterior wall and a closed end and an open end;
a first ridge coupled along a length of said exterior wall of said container;
a second ridge coupled along a length of said exterior wall of said container, said first ridge and said second ridge defining a channel dimensioned to mate with a post; and
a securing device coupled to said container, said securing device dimensioned to secure said container to said post.

2. The post mounted container of claim 1 further comprising a draining spout coupled proximate said closed end of said container.

3. The post mounted container of claim 1 further comprising a lid dimensioned to cover said open end of said container.

4. The post mounted container of claim 3 further comprising at least one handle coupled to said lid.

5. The post mounted container of claim 1 further comprising at least one handle coupled to said exterior wall of said container.

6. The post mounted container of claim 1 further comprising a stabilizing leg having a first end and a second end, said first end of said stabilizing leg coupled to an exterior portion of said closed end of said container and said second end of said stabilizing leg dimensioned to contact an object in order to support said closed end of said container above a ground surface.

7. The post mounted container of claim 6 wherein said exterior portion of said closed end defines a recessed area substantially dimensioned to receive said stabilizing leg in a stored position.

8. The post mounted container of claim 1 wherein said securing device comprising at least one clamp coupled to at least one of said first ridge and said second ridge, said at least one clamp dimensioned to secure at least one of said first ridge and said second ridge to said post.

9. The post mounted container of claim 8 wherein said first ridge and said second ridge having a height tapered from said closed end to said open end of said container wherein said first ridge and said second ridge having a greater height proximate said closed end of said container and a lesser height proximate said open end of said container.

10. The post mounted container of claim 9 further comprising:
a first clamp coupled to said first ridge proximate said closed end of said container, said first clamp dimensioned to secure said container to said post; and
a second clamp coupled to said second ridge proximate said closed end of said container, said second clamp dimensioned to secure said container to said post.

11. The post mounted container of claim 8 wherein said first ridge and said second ridge having a height tapered from said open end to said closed end of said container wherein said first ridge and said second ridge having a greater height proximate said open end of said container and a lesser height proximate said closed end of said container.

12. The post mounted container of claim 11 further comprising:
a first clamp coupled to said first ridge proximate said open end of said container, said first clamp dimensioned to secure said container to said post; and
a second clamp coupled to said second ridge proximate said open end of said container, said second clamp dimensioned to secure said container to said post.

13. The post mounted container of claim 8 further comprising:
a first clamp coupled to said first ridge proximate said closed end of said container, said first clamp dimensioned to secure said container to said post;
a second clamp being coupled to said second ridge proximate said closed end of said container, said second clamp dimensioned to secure said container to said post;
a third clamp being coupled to said first ridge proximate said open end of said container, said third clamp dimensioned to secure said container to said post; and
a fourth clamp being coupled to said second ridge proximate said open end of said container, said fourth clamp dimensioned to secure said container to said post.

14. The post mounted container of claim 1 wherein said channel having a width of between approximately one and six inches and a depth of between approximately one to six inches, said channel being substantially dimensioned to mate with a standard construction post.

15. A post mounted container comprising:
a container having an interior wall and an exterior wall and a closed end and an open end, said exterior wall defining a channel dimensioned to mate with a post; and
a securing device coupled to said container, said securing device dimensioned to secure said container to said post.

16. The post mounted container of claim 15 further comprising a draining spout coupled proximate said closed end of said container.

17. The post mounted container of claim 15 further comprising a lid dimensioned to cover said open end of said container.

18. The post mounted container of claim 17 further comprising at least one handle coupled to said lid.

19. The post mounted container of claim 15 further comprising at least one handle coupled to said exterior wall of said container.

20. The post mounted container of claim 15 further comprising a stabilizing leg having a first end and a second end, said first end of said stabilizing leg coupled to an exterior portion of said closed end of said container and said second end of said stabilizing leg dimensioned to contact an object in order to support said closed end of said container above a ground surface.

21. The post mounted container of claim 20 wherein said exterior portion of said closed end defines a recessed area substantially dimensioned to receive said stabilizing leg in a stored position.

22. The post mounted container of claim 15 wherein said securing device comprising at least one clamp coupled to at least one of a first wall of said channel, said at least one clamp dimensioned to secure said container to said post.

23. The post mounted container of claim 15 further comprising an annular flange formed in said exterior wall of said container proximate said open end of said container and dimensioned to receive a cord-type material, said cord-type material dimensioned to be coupled to said post.

24. The post mounted container of claim 15 wherein said channel having a width of between approximately one to six inches and a depth of between approximately one to six inches, said channel being substantially dimensioned to mate with a standard construction post.

25. A post mounted container comprising:
a container having an interior wall and an exterior wall and a closed end and an open end;
a mounting bracket having a front side and a back side and a top surface and a bottom surface, said mounting bracket being dimensioned to couple to said exterior wall of said container;
a first ridge coupled along a length of said front side of said mounting bracket;
a second ridge coupled along a length of said front side of said mounting bracket, said first ridge and said second ridge defining a channel dimensioned to mate with a post; and
a securing device coupled to at least one of said first ridge and said second ridge, said securing device dimensioned to secure said mounting bracket to said post.

26. The post mounted container of claim 25 wherein:
said exterior wall of said container defining a groove running substantially vertically along a length of said exterior wall of said container;
a tongue coupled along a length of a back portion of said mounting bracket, said tongue being dimensioned to mate with said groove; and
said tongue and groove being dimensioned to fixedly couple said container to said mounting bracket.

27. The post mounted container of claim 25 further comprising a draining spout coupled proximate said closed end of said container.

28. The post mounted container of claim 25 further comprising a lid dimensioned to cover said open end of said container.

29. The post mounted container of claim 28 further comprising at least one handle coupled to said lid.

30. The post mounted container of claim 25 further comprising at least one handle coupled to said exterior wall of said container.

31. The post mounted container of claim 25 further comprising a stabilizing leg having a first end and a second end, said first end of said stabilizing leg coupled to an exterior portion of said closed end of said container and said second end of said stabilizing leg dimensioned to contact an object in order to support said closed end of said container above a ground surface.

32. The post mounted container of claim 32 wherein said exterior portion of said closed end defines a recessed area substantially dimensioned to receive said stabilizing leg in a stored position.

33. The post mounted container of claim 25 wherein said securing device comprising at least one clamp coupled to at least one of said first ridge and said second ridge, said at least one clamp dimensioned to secure at least one of said first ridge and said second ridge to said post.

34. The post mounted container of claim 33 wherein said first ridge and said second ridge having a height tapered from said bottom surface of said mounting bracket to said top surface of said mounting bracket wherein said first ridge and said second ridge having a greater height proximate said bottom surface of said mounting bracket and a lesser height proximate said top surface of said mounting bracket.

35. The post mounted container of claim 34 further comprising:
a first clamp coupled to said first ridge proximate said bottom surface of said mounting bracket, said first clamp dimensioned to secure said container to said post; and
a second clamp coupled to said second ridge proximate said bottom surface of said mounting bracket, said second clamp dimensioned to secure said container to said post.

36. The post mounted container of claim 33 wherein said first ridge and said second ridge having a height tapered from said top surface to said bottom surface of said mounting bracket wherein said first ridge and said second ridge having a greater height proximate said top surface of said mounting bracket and a lesser height proximate said bottom surface of said mounting bracket.

37. The post mounted container of claim 36 further comprising:
a first clamp coupled to said first ridge proximate said top surface of said mounting bracket, said first clamp dimensioned to secure said container to said post; and
a second clamp coupled to said second ridge proximate said top surface of said mounting bracket, said second clamp dimensioned to secure said container to said post.

38. The post mounted container of claim 33 further comprising:
a first clamp coupled to said first ridge proximate said bottom surface of said mounting bracket, said first clamp dimensioned to secure said container to said post;
a second clamp being coupled to said second ridge proximate said bottom surface of said mounting bracket, said second clamp dimensioned to secure said container to said post;
a third clamp being coupled to said first ridge proximate said top surface of said mounting bracket, said third clamp dimensioned to secure said container to said post; and
a fourth clamp being coupled to said second ridge proximate said top surface of said mounting bracket, said fourth clamp dimensioned to secure said container to said post.

39. The post mounted container of claim 25 wherein said channel having a width of between approximately one and six inches and a depth of between approximately one to six inches, said channel being substantially dimensioned to mate with a standard construction post.

40. A method for mounting a post mounted container comprising, in combination, the steps of:
providing a container having an interior wall and an exterior wall and an open end and a closed end;
providing a first ridge coupled along a length of said exterior wall of said container;
providing a second ridge coupled along a length of said exterior wall of said container, said first ridge and said second ridge defining a channel dimensioned to mate with a post;
placing said container in contact with said post with an interior surface of said first ridge proximate a first exterior side of said post and with an interior surface of said second ridge proximate a second exterior side of said post so that said post being mated with said channel of said container; and
securing said container to said post with a securing device.

41. The method of claim 40 further comprising the steps of:
providing a stabilizing leg having a first end and a second end, said first end of said stabilizing leg coupled to an exterior portion of said closed end of said container; and
deploying said second end of said stabilizing leg so that said second end of said stabilizing leg being in contact with an object in order to support said closed end of said container above a ground surface.

42. A method for mounting a post mounted container comprising, in combination, the steps of:
providing a container having an interior wall and an exterior wall and an open end and a closed end;
providing a mounting bracket having a front side and a back side and a top surface and a bottom surface, said mounting bracket being dimensioned to couple to said exterior wall of said container;
providing a first ridge coupled along a length of said front side of said mounting bracket;
providing a second ridge coupled along a length of said front side of said mounting bracket, said first ridge and said second ridge defining a channel dimensioned to mate with a post;
placing said mounting bracket in contact with said post with an interior surface of said first ridge proximate a first exterior side of said post and with an interior surface of said second ridge proximate a second exterior side of said post so that said post being mated with said channel of said container;
securing said mounting bracket to said post with a securing device; and
coupling said container to said mounting bracket.
